(19) United States
(12) Patent Application Publication
(10) Pub. No.: US 2016/0090689 A1
(43) Pub. Date: Mar. 31, 2016

(54) ACOUSTIC EMISSION REDUCTION OF COMPOSITES CONTAINING SEMI-AROMATIC POLYAMIDES

(71) Applicant: E I DU PONT DE NEMOURS AND COMPANY, Wilmington, DE (US)

(72) Inventors: MARTYN DOUGLAS WAKEMAN, GLAND (CH); SHENGMEI YUAN, NEWARK, DE (US); BRYAN BENEDICT SAUER, WILMINGTON, DE (US)

(21) Appl. No.: 14/817,653

(22) Filed: Aug. 4, 2015

Related U.S. Application Data
(60) Provisional application No. 62/057,429, filed on Sep. 30, 2014.

(51) Int. Cl. D06M 15/59; C08J 5/24

(52) U.S. Cl. CPC D06M 15/59; C08J 5/24; C08J 2377/06; D06M 2101/40

(57) ABSTRACT

The present invention relates to a composite structure having a surface, which surface has at least a portion made of a surface resin composition, and comprising a woven glass fiber fabric, said woven glass fiber fabric being fully impregnated with a matrix resin composition, wherein
a. the matrix resin composition comprises a blend of PA6T/DT and PA66/6T, preferably with a weight ratio between from about 30:70 to about 70:30, more preferably with a weight ratio of about 50:50
b. the surface resin composition is independently selected from an amorphous polyamide composition comprising PA6I/6T or a polyamide composition comprising a blend of PA66 and PA6, preferably the weight ratio of PA66 and PA6 in the blend of the surface resin composition is of between 100:0 to 50:50, more preferably 75:25
   and wherein
c. the woven glass fiber fabric has a basis weight of between 280 to 320 g/m²
d. the coverage of the woven glass fiber fabric is of between 95% to 100%.

### CROSS REFERENCE TO RELATED APPLICATIONS

This application claims the benefit of U.S. Provisional Application No. 62/057,429, filed Sep. 30, 2014, now pending, the entire disclosure of which is incorporated herein by reference.

### FIELD OF THE INVENTION

The present invention relates to the field of semi-aromatic polyamide composite structures and processes for their preparation.

### BACKGROUND OF THE INVENTION

With the aim of replacing metal parts for weight saving and cost reduction while having comparable or superior mechanical performance, structures based on composite materials comprising a polymer matrix containing a fibrous material have been developed. With this growing interest, fiber reinforced plastic composite structures have been designed because of their excellent physical properties resulting from the combination of the fibrous material and the polymer matrix and are used in various end-use applications. Manufacturing techniques have been developed for improving the impregnation of the fibrous material with a polymer matrix to optimize the properties of the composite structure.

In highly demanding applications, such as for example structural parts in automotive, industrial, and aerospace applications, composite materials are desired due to a unique combination of lightweight, high strength and temperature resistance.

High performance composite structures can be obtained using thermosetting resins or thermoplastic resins as the polymer matrix. Thermoplastic-based composite structures present several advantages over thermoset-based composite structures such as, for example, the fact that they can be post-formed or reprocessed by the application of heat and pressure, that a reduced time is needed to make the composite structures because no curing step is required, and their increased potential for recycling. Indeed, the time consuming chemical reaction of cross-linking for thermosetting resins (curing) is not required during the processing of thermoplastics. Among thermoplastic resins, polyamides are particularly well suited for manufacturing composite structures. Thermoplastic polyamide compositions are desirable for use in a wide range of applications including parts used in automobiles, electrical/electronic parts, household appliances and furniture because of their good mechanical properties, heat resistance, impact resistance and chemical resistance and because they may be conveniently and flexibly molded into a variety of articles of varying degrees of complexity and intricacy.

Semi-aromatic polyamide composites are of interest as materials that combine the fast transformation times of thermoplastic composites and the good retention of mechanical properties of thermo-set like materials within typical application operational temperature ranges. It is well known in the art that partially aromatic polyamides with high glass transition temperatures offer these advantages. Extending such advantages to composite structures with higher and aligned fiber content systems would result in materials suited to structural applications in a variety of industries and applications.

WO 2007/149300, WO 2012/058348 and WO 2012/058350 disclose semi-aromatic polyamide composite structures and processes for their preparation. The disclosed composite structures while having good mechanical properties present micro-cracking and emit acoustic energy upon cooling or upon mechanical loading.

Micro-cracking can lead to reduced mechanical properties, premature aging and problems related to deterioration of the composite structure with use and time.

Also, when over-molding composite structure, i.e. when the formed composite structure obtained by lamination is over-molded with a second resin or composite system, it is known that using a surface resin composition comprised of a compatible or compatibilized second resin species, or blend of resins species aids this process. Therefore, when the matrix resin composition or the surface resin composition contain semi-aromatic polyamide it is desirable to suppress acoustic emission and micro-cracking.

The composite structure must also have sufficient properties to resist mechanically induced stress that may be applied during operation and use of the composite in a molded product with good long term durability such as is commonly appreciated with composite materials.

Therefore, there is a need for a semi-aromatic polyamide composite structure having high glass transition temperature that exhibits good mechanical properties, especially flexural strength but does not present micro-cracking or emit acoustic energy upon cooling or upon mechanical loading.

### SUMMARY OF THE INVENTION

Described herein is a composite structure having a surface, which surface has at least a portion made of a surface resin composition, and comprising a woven glass fiber fabric, said woven glass fiber fabric being fully impregnated with a matrix resin composition, wherein
a. the matrix resin composition comprises a blend of PA6T/DT and PA66/6T, preferably with a weight ratio between from about 30:70 to about 70:30, more preferably with a weight ratio of about 50:50
b. the surface resin composition is independently selected from an amorphous polyamide composition comprising PA6I/6T or a polyamide composition comprising a blend of PA66 and PA6, preferably the weight ratio of PA66 and PA6 in the blend of the surface resin composition is of between 100:0 to 50:50, more preferably 75:25
   and wherein
c. the woven glass fiber fabric has a basis weight of between 280 to 320 g/m²
d. the coverage of the woven glass fiber fabric is of between 95% to 100%.

Preferably, the composite structure of the present invention has a fiber volume fraction of between 45 to 60%.

In one embodiment, the composite structures according to the present invention further comprise a fibrous material made of carbon fibers.

The composite structure according to the present invention are in the form of a sheet structure, or of a component for automobiles, trucks, commercial airplanes, aerospace, rail, household appliances, computer hardware, hand held devices, recreation and sports, structural component for machines, structural components for buildings, structural components for photovoltaic equipment or structural components for mechanical devices.

### DETAILED DESCRIPTION

### Definitions

As used herein, the term “a” refers to one as well as to at least one and is not an article that necessarily limits its referent noun to the singular.

As used herein, the terms “about” and “at or about” are intended to mean that the amount or value in question may be the value designated or some other value about the same. The phrase is intended to convey that similar values promote equivalent results or effects according to the invention.

As used herein, the term “melting point” in reference to a polyamide refers to the melting point of the pure resin as determined with differential scanning calorimetry (DSC) at a scan rate of 10° C./min in the first heating scan, wherein the melting point is taken at the maximum of the endothermic peak. In customary measurements of melting behavior of blends of polymers, more than one heating scans may be performed on a single specimen, and the second and/or later scans may show a different melting behavior from the first scan. This different melting behavior may be observed as a shift in temperature of the maximum of the endothermic peak and/or as a broadening of the melting peak with possibly more than one peaks, which may be an effect of possible transamidation in the case of more than one polyamides. However, when selecting polyamides for the scope of the current invention, always the peak of the melting endotherm of the first heating scan of the single polyamide is used. As used herein, a scan rate is an increase of temperature per unit time. Sufficient energy must be supplied to maintain a constant scan rate of 10° C./min until a temperature of at least 30° C. and preferably at least 50° C. above the melting point is reached.

As used herein, the term “fibrous material” means a material that is any suitable mat, fabric, or web form known to those skilled in the art. The fibers or strands used to form the fibrous material are interconnected (i.e. at least one fiber or strand is touching at least one other fiber or strand to form a continuous material) or touching each other so that a continuous mat, web or similar structure is formed.

As used herein, the term Fibrous layer “basis weight” refers to the weight per unit area of the dry fibrous layer.

The filament count in a fiber bundle or tow is useful in defining a carbon fiber tow size. Common sizes include 12,000 (12 k) filaments per tow bundle, or 50,000 (50 k) filaments per tow bundle.

As used herein, the term “impregnated” means the polyamide resin composition flows into the cavities and void spaces of the fibrous material.

As used herein, the term “fully impregnated” means that the fibrous material is impregnated with the polyamide resin such that the void content, or the part of the fibrous material not impregnated, is less than 2%. Voids were measured according to ISO7822 1990(en) following method C, Statistical counting. Samples were prepared for optical microscopy by embedding in resin and polishing to give clear contrast between fiber, resin, and voids. Images were taken using an Olympus optical microscope with automatic X-Y-Z stage to capture multiple images of the sample. An area of the full thickness and 15-25 mm length was imaged with sufficient resolution to detect both intra-bundular and inter bundular voids. The voids were then counted by segmenting the grey scale image into a binary image, where all features except voids were removed, and the void area automatically counted using “Analysis” software.

As used herein, the term “coverage” means the percentage of the fibrous textile surface that is blocking to a back illuminated light source compared with the percentage surface area that permits light to pass through the fibrous textile structure. A back lit glass, with colored film used to increase contrast, was used with a tripod mounted camera, fixed in position for a series of images, to record the resulting image where the ratio of dark to light areas is determined by statistical counting techniques. This is additive to a conventional definition of coverage to include the aspect ratio or spreading of the warp or weft threads. Conventionally, cover factor is a number, derived from the number of warp (or weft) threads per unit length and the linear density of the yarns, that indicates the extent to which the area of a woven fabric is covered by the warp (or weft) yarns.

The composite structure according to the present invention has good mechanical properties and allows a good adhesion when a part made of an over-molding resin composition comprising a thermoplastic polyamide is adhered onto at least a portion of the surface of the composite structure. A good impact resistance and flexural strength of the composite structure and a good adhesion between the composite structure and the over-molding resin leads to structures exhibiting good resistance to deterioration and/or delamination of the structure with use and time.

The present invention relates to composite structures and processes to make them. The composite structure according to the present invention comprises a woven glass fiber fabric and optionally a fibrous material made of carbon fibers that are impregnated with a matrix resin composition. At least a portion of the surface of the composite structure is made of a surface resin composition. The matrix resin composition and the surface resin composition may be different or may be the same.

### Woven Glass Fiber Fabric

As used herein, the term “woven glass fiber fabric being impregnated with a matrix resin composition” means that the matrix resin composition encapsulates and embeds the glass fibers so as to form an interpenetrating network of glass fibers substantially surrounded by the matrix resin composition. As used herein, the term “fibrous material made of carbon fibers being impregnated with a matrix resin composition” means that the matrix resin composition encapsulates and embeds the carbon fibers so as to form an interpenetrating network of carbon fibers substantially surrounded by the matrix resin composition. For purposes herein, the term “fiber” refers to a macroscopically homogeneous body having a high ratio of length to width across its cross-sectional area perpendicular to its length. The fiber cross section can be any shape, but is preferably round. Depending on the end-use application of the composite structure and the required mechanical properties, more than one woven glass fiber fabric can be used, either by using several same woven glass fiber fabric or a combination of different woven glass fiber fabric and also a combination of woven glass fabric and fibrous material made of carbon fibers, i.e. the composite structure according to the present invention may comprise one or more woven glass fiber fabric and/or a combination of woven glass fiber fabric and fibrous material made of carbon fibers. The composite structure may also only comprise fibrous material made of carbon fibers. A combination of different fibers can be used such as for example a composite structure comprising one or more central layers made of glass fibers and one or more surface layers made of carbon fibers or glass fibers. When a fibrous material made of carbon fibers is present in the composite structure of the present invention, the fibrous material made of carbon fibers is also impregnated with the matrix resin composition.

Preferably, in the woven glass fiber fabric of the present invention, the glass fibers are E-glass filaments with a diameter between 8 and 30 microns and preferably with a diameter between 9 to 24 microns.

Preferably, the woven glass fiber fabric has a basis weight of between 280 to 320 g/m², more preferably of between 290 to 310 g/m².

Preferably, the woven glass fiber fabric has a coverage of between 95 to 100%, more preferably of between 99 to 100%.

In a preferred embodiment, the woven glass fiber fabric has a twill 2/2 weave style, a filament diameter of about 9 microns, and the yarns have a weight of 3*68 Tex in the warp direction and 204 Tex in the weft direction and the nominal construction of the woven glass fiber fabric is 7 yarns/cm in the warp and weft direction, with a thickness of 0.23 mm.

The fibrous material made of carbon fibers is selected from unidirectional non crimp fabric or a woven fabric, wherein said structures are made of carbon fibers. More preferably, the woven fabric fibrous material made of carbon fibers is made with carbon fibers having a tow size greater than or equal to 12,000, and the unidirectional non crimp fabric is made with carbon fibers having a tow size greater than or equal to 50,000.

Preferably, the fibrous woven fabric material made of carbon fibers has a basis weight lower than or equal to 600 g/m², more preferably between 200 g/m² to 330 g/m². and the unidirectional non crimp fabric has a basis weight lower than or equal to 300 g/m², more preferably between 100 g/m² to 300 g/m².

In a preferred embodiment, the woven carbon fiber fabric has a twill 2/2 weave style, a basis weight of 320 g/m², with 12 k yarns in the warp and the weft direction. In a preferred embodiment, the unidirectional non crimp fabric is made from 50 k carbon roving and has a basis weight of 200 g/m².

The woven glass fiber fabric or the fibrous material made of carbon fibers used in the composite structure of the invention cannot be wholly comprised of short chopped fibers or particles. To be clear, the woven glass fiber fabric or the fibrous material made of carbon fibers in the composite structure cannot be fibers or particles which are not interconnected to form a continuous mat, web or similar layered structure. In other words, they cannot be independent or single fibers or particles surrounded by the polyamide matrix resin composition.

Preferably, the ratio between woven glass fiber fabric and/or the fibrous material made of carbon fibers and the polymer materials in the composite structure, i.e. woven glass fiber fabric and/or the fibrous material made of carbon fibers in combination with the matrix resin composition and the surface resin composition, is at least 30 volume percent fibrous material and more preferably between 40 and 60 volume percent fibrous material, the percentage being a volume-percentage based on the total volume of the composite structure.

### Matrix Resin Composition

The matrix resin composition is selected from polyamide compositions comprising a blend of semi-aromatic polyamides. Preferably, the matrix resin composition is selected from polyamide compositions comprising a blend of semi-aromatic semi-crystalline polyamides (A) or a blend of semi-aromatic semi-crystalline polyamides (A) with a semi-aromatic amorphous polyamide (B).

Polyamides are condensation products of one or more dicarboxylic acids and one or more diamines, and/or one or more aminocarboxylic acids, and/or ring-opening polymerization products of one or more cyclic lactams. Polyamides may be fully aliphatic or semi-aromatic and are described hereafter.

The term “semi-aromatic” describes polyamides that comprise at least some monomers containing aromatic groups, in comparison with “fully aliphatic” polyamide which describes polyamides comprising aliphatic carboxylic acid monomer(s) and aliphatic diamine monomer(s). The one or more semi-aromatic polyamides may be derived from one or more aliphatic carboxylic acid components and aromatic diamine components such as for example m-xylylenediamine and p-xylylenediamine, it may be derived from one or more aromatic carboxylic acid components, such as terephthalic acid, and one or more aliphatic diamine components, it may be derived from mixtures of aromatic and aliphatic dicarboxylic acid components and mixtures of aromatic and aliphatic diamine components, it may be derived from mixtures of aromatic and aliphatic carboxylic acids and aliphatic diamines or aromatic diamines, it may be derived from aromatic or aliphatic carboxylic acids with mixtures of aliphatic and aromatic diamines.

Preferably, the one or more semi-aromatic polyamides are formed from one or more aromatic carboxylic acid components and one or more aliphatic diamine components. The one or more aromatic carboxylic acids can be, for example, terephthalic acid or mixtures of terephthalic acid and one or more other carboxylic acids, such as isophthalic acid, substituted phthalic acid such as for example 2-methylterephthalic acid and unsubstituted or substituted isomers of naphthalenedicarboxylic acid. Preferably, the one or more aromatic carboxylic acids are selected from terephthalic acid, isophthalic acid and mixtures thereof and more preferably, the one or more carboxylic acids are mixtures of terephthalic acid and isophthalic acid, wherein the mixture contains at least 55 mole-% of terephthalic acid. More preferably, the one or more carboxylic acids is 100% terephthalic acid. Furthermore, the one or more carboxylic acids can be mixed with one or more aliphatic carboxylic acids, like adipic acid; pimelic acid; suberic acid; azelaic acid; sebacic acid and dodecanedioic acid, adipic acid being preferred. More preferably the mixture of terephthalic acid and adipic acid comprised in the one or more carboxylic acids mixtures of the one or more semi-aromatic polyamide contains at least 55 mole-% of terephthalic acid. The one or more semi-aromatic polyamides described herein comprises one or more aliphatic diamines that can be chosen among diamines having four or more carbon atoms, including, but not limited to tetramethylene diamine, hexamethylene diamine, octamethylene diamine, decamethylene diamine, 2-methylpentamethylene diamine, 2-ethyltetramethylene diamine, 2-methyloctamethylene diamine; trimethylhexamethylene diamine, bis(p-aminocyclohexyl)methane; and/or mixtures thereof. Preferably, the one or more diamines of the one or more semi-aromatic polyamides described herein are selected from hexamethylene diamine, 2-methyl pentamethylene diamine and mixtures thereof, and more preferably the one or more diamines of the one or more semi-aromatic polyamides are selected from hexamethylene diamine and mixtures of hexamethylene diamine and 2-methyl pentamethylene diamine wherein the mixture contains at least 50 mole-% of hexamethylene diamine (the mole-% being based on the diamines mixture).

Examples of semi-aromatic polyamides useful in the polyamide composition described herein are commercially available under the trademark Zytel® HTN from E. I. du Pont de Nemours and Company, Wilmington, Del.

The term “semi-crystalline” semi-aromatic polyamide refers to those polyamides which are partly crystalline as shown by the presence of an endotherm crystalline melting peak in a Differential Scanning calorimeter (“DSC”) measurement (ASTM D-3417), 10° C./minute heating rate.

Preferred semi-crystalline semi-aromatic polyamides (A) are selected from the group consisting of poly(ε-caprolactam/tetramethylene terephthalamide) (PA6/4T), poly(ε-caprolactam/hexamethylene terephthalamide) (PA6/6T), poly(ε-caprolactam/decamethylene terephthalamide) (PA6/10T), poly(ε-caprolactam/dodecamethylene terephthalamide) (PA6/12T), poly(hexamethylene decanediamide/hexamethylene terephthalamide) (PA610/6T), poly(hexamethylene dodecanediamide/hexamethylene terephthalamide) (PA612/6T), poly(hexamethylene tetradecanediamide/hexamethylene terephthalamide) (PA614/6T), poly(ε-caprolactam/hexamethylene isophthalamide/hexamethylene terephthalamide) (PA6/6I/6T), poly(2-methylpentamethylene hexanediamide/hexamethylene hexanediamide/hexamethylene terephthamide) (PA D6/66/ /6T), poly(hexamethylene terephthamide/2-methylpentamethylene terephthamide) (PA6TDT), poly(hexamethylene hexanediamide/hexamethylene terephthamide (PA66/6T), poly(hexamethylene terephthamide/hexamethylene isophthamide (PA6T/6I), poly(hexamethylene hexanediamide/hexamethylene terephthamide/hexamethylene isophthamide (PA66/6T/6I), poly(decamethylene decanediamide/decamethylene terephthalamide) (PA1010/10T) poly(decamethylene decanediamide/dodecamethylene decanediamide/decamethylene terephthalamide/dodecamethylene terephthalamide (PA1010/1210/10T/12T), poly(11-aminoundecanamide/tetramethylene terephthalamide) (PA11/4T), poly(11-aminoundecanamide/hexamethylene terephthalamide) (PA11/6T), poly(11-aminoundecanamide/decamethylene terephthalamide) (PA11/10T), poly(11-aminoundecanamide/dodecamethylene terephthalamide) (PA11/12T), poly(12-aminododecanamide/tetramethylene terephthalamide) (PA12/4T), poly(12-aminododecanamide/hexamethylene terephthalamide) (PA12/6T), poly(12-aminododecanamide/decamethylene terephthalamide) (PA12/10T), and poly(dodecamethylene dodecanediamide/dodecamethylene dodecanediamide/dodecamethylene terephthalamide)) (PA1212/12T). Particularly preferred semi-crystalline semi-aromatic polyamides (A) are selected from the group consisting of poly(hexamethylene terephthamide/2-methylpentamethylene terephthamide) (PA6TDT), poly(hexamethylene hexanediamide/hexamethylene terephthamide (PA66/6T), poly(hexamethylene terephthamide/hexamethylene isophthamide (PA6T/6I), poly(hexamethylene hexanediamide/hexamethylene terephthamide/hexamethylene isophthamide (PA66/6T/6I).

The term “amorphous” semi-aromatic polyamide refers to those polyamides which are lacking in crystallinity as shown by the lack of an endotherm crystalline melting peak in a Differential Scanning calorimeter (“DSC”) measurement (ASTM D-3417), 10° C./minute heating rate.

Preferred amorphous semi-aromatic polyamides (B) comprise isophthalic acid as aromatic carboxylic acids, wherein the amount of isophthalic acid in the semi-crystalline semi-aromatic polyamide is at least 60 mole-%.

Examples of amorphous semiaromatic polyamides (B) that are also known as transparent semiaromatic polyamides can be found in M.I. Kohan Nylon plastics handbook, Hanser, Munich (1995), page 377 to 380 the content of which is incorporated herein by reference. Preferred amorphous semiaromatic polyamides (B) are selected from the group consisting of poly(hexamethylene terephthamide/hexamethylene isophthamide (PA6T/6I), poly(hexamethylene hexanediamide/hexamethylene terephthamide/hexamethylene isophthamide (PA66/6T/6I) wherein the amount of isophthalic acid in the semi-crystalline semi-aromatic polyamide is at least 60 mole-%. Particularly preferred amorphous semiaromatic polyamides (B) are poly(hexamethylene terephthamide/hexamethylene isophthamide (PA6T/6I) in a molar ratio 6T:6I of approximately 30:70.

The matrix resin composition described herein comprises a blend of semi-aromatic polyamides.

In one embodiment, the matrix resin composition is selected from polyamide compositions comprising a blend of a semi-aromatic semi-crystalline polyamide (A). Preferably, the matrix resin composition comprises a blend of PA6T/DT and PA66/6T. The amount of terephthalic acid in the semi-aromatic semi-crystalline polyamide (A) is at least 55 mole-%. More preferably, the weight ratio of PA6T/DT and PA66/6T in the blend of the matrix resin composition is between from about 30:70 to 70:30, even more preferably the weight ratio is 50:50 of P6T/DT and PA66/6T.

In another embodiment, the matrix resin composition is selected from polyamide compositions comprising a blend of a semi-aromatic semi-crystalline polyamide (A) with a semi-aromatic amorphous polyamide (B). Preferably, the matrix resin composition comprises a blend of PA6T/DT, PA66/6T and PA6I/6T. The amount of terephthalic acid in the semi-crystalline semi-aromatic polyamide (A) is at least 55 mole-% and the amount of isophthalic acid in the amorphous semi-aromatic polyamide is at least 60 mole-%. More preferably, the weight ratio of PA6T/DT, PA66/6T and PA6I/6T in the blend of the matrix resin composition is 40:40:20.

### Surface Resin Composition

The surface resin composition is selected from polyamide compositions comprising a semi-aromatic amorphous polyamide (B) or is selected from a blend of aliphatic polyamides (C). Preferably, the matrix resin composition is selected from polyamide compositions comprising a blend of semi-aromatic semi-crystalline polyamides (A) with a semi-aromatic amorphous polyamide (B).

In one embodiment, the surface resin composition is selected from polyamide compositions comprising a blend of a semi-aromatic semi-crystalline polyamide (A) with a semi-aromatic amorphous polyamide (B). Preferably, the surface resin composition comprises a blend of PA6T/DT, PA66/6T and PA6I/6T. The amount of terephthalic acid in the semi-crystalline semi-aromatic polyamide (A) is at least 55 mole-% and the amount of isophthalic acid in the amorphous semi-aromatic polyamide is at least 60 mole-%. More preferably, the weight ratio of PA6T/DT, PA66/6T and PA6I/6T in the blend of the surface resin composition is 40:40:20.

In a preferred embodiment, the matrix resin composition and the surface resin composition are the same and are selected from polyamide compositions comprising a blend of a semi-aromatic semi-crystalline polyamide (A) with a semi-aromatic amorphous polyamide (B) as described above.

In another embodiment, the surface resin composition is selected from polyamide compositions comprising a blend of fully aliphatic polyamide (C). Preferably, the surface resin composition comprises a blend of PA66 and PA6. More preferably, the weight ratio of PA66 and PA6 in the blend of the surface resin composition is between from about 100:00 to 50:50, even more preferably the weight ratio is 75:25 of PA66 and PA6.

Fully aliphatic polyamide resins (C) are formed from aliphatic and alicyclic monomers such as diamines, dicarboxylic acids, lactams, aminocarboxylic acids, and their reactive equivalents. A suitable aminocarboxylic acid includes 11-aminododecanoic acid. In the context of this invention, the term “fully aliphatic polyamide resin” refers to copolymers derived from two or more such monomers and blends of two or more fully aliphatic polyamide resins. Linear, branched, and cyclic monomers may be used.

Carboxylic acid monomers useful in the preparation of fully aliphatic polyamide resins include, but are not limited to, aliphatic carboxylic acids, such as for example adipic acid (C6), pimelic acid (C7), suberic acid (C8), azelaic acid (C9), sebacic acid (C10), dodecanedioic acid (C12) and tetradecanedioic acid (C14). Useful diamines include those having four or more carbon atoms, including, but not limited to tetramethylene diamine, hexamethylene diamine, octamethylene diamine, decamethylene diamine, 2-methylpentamethylene diamine, 2-ethyltetramethylene diamine, 2-methyloctamethylene diamine; trimethylhexamethylene diamine and/or mixtures thereof. Suitable examples of fully aliphatic polyamide resins include PA6; PA66; PA46; PA610; PA612; PA614; P 613; PA615; PA616; PA11; PA 12; PA10; PA 912; PA913; PA914; PA915; PA616; PA936; PA1010; PA1012; PA1013; PA1014; PA1210; PA1212; PA1213; PA1214 and copolymers and blends of the same. Preferred examples of fully aliphatic polyamide resins comprised in the polyamide compositions described herein include PA6; PA11; PA12; PA4,6; PA66; PA,10; PA612; PA1010 and copolymers and blends of the same.

The surface resin composition described herein and/or the matrix resin composition may further comprise one or more impact modifiers, one or more heat stabilizers, one or more oxidative stabilizers, one or more reinforcing agents, one or more rheology modifiers, one or more ultraviolet light stabilizers, one or more flame retardant agents or mixtures thereof.

As mentioned above, the matrix resin composition and the surface resin composition may be identical or different. With the aim of increasing the impregnation rate of the fibrous material, the melt viscosity of the compositions may be reduced and especially the melt viscosity of the matrix resin composition.

The surface resin composition described herein and/or the matrix resin composition may further comprise modifiers and other ingredients, including, without limitation, flow enhancing additives, lubricants, antistatic agents, coloring agents (including dyes, pigments, carbon black, and the like), nucleating agents, crystallization promoting agents and other processing aids known in the polymer compounding art.

Fillers, modifiers and other ingredients described above may be present in the composition in amounts and in forms well known in the art, including in the form of so-called nano-materials where at least one of the dimensions of the particles is in the range of 1 to 1000 nm.

Preferably, the surface resin compositions and the matrix resin compositions are melt-mixed blends, wherein all of the polymeric components are well-dispersed within each other and all of the non-polymeric ingredients are well-dispersed in and bound by the polymer matrix, such that the blend forms a unified whole. Any melt-mixing method may be used to combine the polymeric components and non-polymeric ingredients of the present invention. For example, the polymeric components and non-polymeric ingredients may be added to a melt mixer, such as, for example, a single or twin-screw extruder; a blender; a single or twin-screw kneader; or a Banbury mixer, either all at once through a single step addition, or in a stepwise fashion, and then melt-mixed. When adding the polymeric components and non-polymeric ingredients in a stepwise fashion, part of the polymeric components and/or non-polymeric ingredients are first added and melt-mixed with the remaining polymeric components and non-polymeric ingredients being subsequently added and further melt-mixed until a well-mixed composition is obtained.

Depending on the end-use application, the composite structure according to the present invention may have any shape. In a preferred embodiment, the composite structure according to the present invention is in the form of a sheet structure.

In another aspect, the present invention relates to a process for making the composite structures described above and the composite structures obtained thereof. The process for making a composite structure having a surface comprises a step of i) impregnating the woven glass fiber fabric and optionally the fibrous material made of carbon fibers with the matrix resin composition, wherein at least a portion of the surface of the composite structure is made of the surface resin composition. Preferably, the woven glass fiber fabric and optionally the fibrous material made of carbon fibers is impregnated with the matrix resin by thermopressing. During thermopressing, the woven glass fiber fabric and optionally the fibrous material made of carbon fibers, the matrix resin composition and the surface resin composition undergo heat and pressure in order to allow the resin compositions to melt and penetrate through the woven glass fiber fabric and optionally the fibrous material made of carbon fibers and, therefore, to impregnate said woven glass fiber fabric and optionally the fibrous material made of carbon fibers.

Typically, thermopressing is made at a pressure between 2 and 100 bars and more preferably between 10 and 60 bars and a temperature which is above the melting point of the matrix resin composition and the surface resin composition, preferably at least about 20° C. above the melting point to enable a proper impregnation. Heating may be done by a variety of means, including contact heating, radiant gas heating, infra red heating, convection or forced convection air heating, induction heating, microwave heating or combinations thereof.

The impregnation pressure can be applied by a static process or by a continuous process (also known as dynamic process), a continuous process being preferred for reasons of speed. Examples of impregnation processes include without limitation vacuum molding, in-mold coating, cross-die extrusion, pultrusion, wire coating type processes, lamination, stamping, diaphragm forming or press-molding, lamination being preferred. During lamination, heat and pressure are applied to the woven glass fiber fabric and when optionally used, the fibrous material made of carbon fibers, the matrix resin composition and the surface resin composition through opposing pressured rollers or belts in a heating zone, preferably followed by the continued application of pressure in a cooling zone to finalize consolidation and cool the impregnated woven glass fiber fabric and optionally the fibrous material made of carbon fibers by pressurized means. Examples of lamination techniques include without limitation calendering, flatbed lamination and double-belt press lamination. When lamination is used as the impregnating process, preferably a double-belt press is used for lamination.

The matrix resin composition and the surface resin composition are applied to the woven glass fiber fabric and optionally the fibrous material made of carbon fibers by conventional means such as for example powder coating, film lamination, extrusion coating or a combination of two or more thereof, provided that the surface resin composition is applied on at least a portion of the surface of the composite structure, which surface is exposed to the environment of the composite structure.

During a powder coating process, a polymer powder is applied to the woven glass fiber fabric and optionally the fibrous material made of carbon fibers. The powder may be applied onto the woven glass fiber fabric and optionally the fibrous material made of carbon fibers by scattering, sprinkling, spraying, thermal or flame spraying, or fluidized bed coating methods or aqueous suspensions. Optionally, the powder coating process may further comprise a step which consists of a post sintering step of the powder on the woven glass fiber fabric and optionally the fibrous material made of carbon fibers. The matrix resin composition and the surface resin composition are applied to the woven glass fiber fabric and optionally the fibrous material made of carbon fibers such that at least a portion of the surface of the composite structure is made of the surface resin composition. Subsequently, thermopressing is performed on the powder coated woven glass fiber fabric and optionally the fibrous material made of carbon fibers, with an optional preheating of the powder coated woven glass fiber fabric and optionally the fibrous material made of carbon fibers outside of the pressurized zone.

During film lamination, one or more films made of the matrix resin composition and one or more films made of the surface resin composition which have been obtained by conventional extrusion methods known in the art such as for example blow film extrusion, cast film extrusion and cast sheet extrusion are applied to the woven glass fiber fabric and optionally the fibrous material made of carbon fibers, e.g. by layering. Subsequently, thermopressing is performed on the assembly comprising the one or more films made of the matrix resin composition and the one or more films made of the surface resin composition and the one or more woven glass fiber fabrics and optionally the one or more fibrous material made of carbon fibers. In the resulting composite structure, the films melt and penetrate around the woven glass fiber fabric and optionally the fibrous material made of carbon fibers as a polymer continuum surrounding the woven glass fiber fabric and optionally the fibrous material made of carbon fibers.

During extrusion coating, pellets and/or granulates made of the matrix resin composition and pellets and/or granulates made of the surface resin composition are melted and extruded through one or more flat dies so as to form one or more melt curtains which are then applied onto the woven glass fiber fabric and optionally the fibrous material made of carbon fibers by laying down the one or more melt curtains. Subsequently, thermopressing is performed on the assembly comprising the matrix resin composition, the surface resin composition and the one or more woven glass fiber fabric and optionally the one or more fibrous material made of carbon fibers.

Depending on the end-use application, the composite structure obtained under step i) may be shaped into a desired geometry or configuration, or used in sheet form. The process for making a composite structure according to the present invention may further comprise a step ii) of shaping the composite structure, said step arising after the impregnating step i). The step of shaping the composite structure obtained under step i) may be done by compression molding, stamping or any technique using heat and/or pressure. Preferably, pressure is applied by using a hydraulic molding press. During compression molding or stamping, the composite structure is preheated to a temperature above the melt temperature of the surface resin composition and is transferred to a forming or shaping means such as a molding press containing a mold having a cavity of the shape of the final desired geometry whereby it is shaped into a desired configuration and is thereafter removed from the press or the mold after cooling to a temperature below the melt temperature of the surface resin composition and preferably below the melt temperature the matrix resin composition.

The composite structures of the invention are particularly suited to be overmoulded with an overmoulding resin composition that is selected from polyamide compositions.

The composite structures according to the present invention may be used in a wide variety of applications such as for example as components for automobiles, trucks, commercial airplanes, aerospace, rail, household appliances, computer hardware, hand held devices, recreation and sports, structural component for machines, structural components for buildings, structural components for photovoltaic equipments or structural components for mechanical devices.

Examples of automotive applications include without limitation seating components and seating frames, engine cover brackets, engine cradles, suspension arms and cradles, spare tire wells, chassis reinforcement, floor pans, front-end modules, steering column frames, instrument panels, door systems, body panels (such as horizontal body panels and door panels), tailgates, hardtop frame structures, convertible top frame structures, roofing structures, engine covers, housings for transmission and power delivery components, oil pans, airbag housing canisters, automotive interior impact structures, engine support brackets, cross car beams, bumper beams, pedestrian safety beams, firewalls, rear parcel shelves, cross vehicle bulkheads, pressure vessels such as refrigerant bottles and fire extinguishers and truck compressed air brake system vessels, hybrid internal combustion/electric or electric vehicle battery trays, automotive suspension wishbone and control arms, suspension stabilizer links, leaf springs, vehicle wheels, recreational vehicle and motorcycle swing arms, fenders, roofing frames and tank flaps.
Examples of household appliances include without limitation washers, dryers, refrigerators, air conditioning and heating. Examples of recreation and sports include without limitation inline-skate components, baseball bats, hockey sticks, ski and snowboard bindings, rucksack backs and frames, and bicycle frames. Examples of structural components for machines include electrical/electronic parts such as for example housings for hand held electronic devices, computers.

### Examples

### Materials

The materials below are comprised in the compositions used in the Examples and Comparative Examples.

As required for the manufacturing process and well-known to those skilled in the art, the matrix resin compositions and/or the surface resin compositions contained up to 6 weight percent of heat stabilizers, antioxidants and metal deactivators.

### Matrix and Surface Resin Composition

Resin Composition 1(PA66 PA6): is a blend of polyamide resin comprising adipic acid and 1,6-hexamethylenediamine with a weight average molecular weight as polymerized of around 20000-35000 Daltons, commercially available from E. I. du Pont de Nemours and Company as PA66, with a polyamide resin made of ε-caprolactam having a melting point of about 220° C., called PA6 and commercially available, for example, from BASF corporation. The blend is in a weight ratio of 75:25 or 50:50.
Resin Composition 2 (PA66): is a polyamide resin comprising adipic acid and 1,6-hexamethylenediamine with a weight average molecular weight as polymerized of around 20000-35000 Daltons and is commercially available from E. I. du Pont de Nemours and Company as PA66. The polyamide resin has a melting point of about 260° C. to about 265° C.
Resin Composition 3 (PA6T/66): is a polyamide resin made from terephthalic acid, adipic acid and hexamethylenediamine wherein the two acids are used in a 55:45 molar ratio; having a melting point of about 310° C. and an inherent viscosity (IV), according to ASTM D2857, typically about 1.07. This semi-aromatic polyamide is called PA6T/66 and is available from E.I. DuPont de Nemours and Company, Wilmington, Del.
Resin Composition 4 (PA6T/DT): is a polyamide resin made of terephthalic acid and 1,6-hexamethylenediamine (HMD) and 2-methylpentamethylenediamine (MPMD) (HMD:MPMD=50:50). The polyamide resin has a melting point of about 297° C. to about 303° C. This semi-aromatic polyamide is called PA6T/DT and is commercially available from E. I. du Pont de Nemours and Company, Wilmington, Del.
Resin Composition 5 (PA6T/66 PA6T/DT): is a blend of resin composition 3 (PA6T/66) and resin composition 4 (PA6T/DT) in a weight ratio of 50:50.
Resin Composition 6 (PA6I/6T): is a polyamide resin made of terephthalic acid, isophthalic acid, and 1,6-hexamethylenediamine. This amorphous semi-aromatic polyamide, wherein the two acids are used in a 70:30 molar ratio, has a glass transition temperature of about 120° C. to about 130° C. The polyamide resin is called PA6I/6T and is commercially available from E. I. du Pont de Nemours and Company.
Resin Composition 7 (PA6T/DT PA6T/66 PA6I/6T): is a blend of resin composition 6 (PA6T/DT), resin composition 5 (PA6T/66) and resin composition 8 (PA6I/6T) in a weight ratio of 40:40:20.

Preparation of Films from the Resin Compositions:

Films were melt cast to the desired thickness using commercial scale film casting equipment and prepared into rolls for subsequent lamination.

### Woven Glass Fiber Fabric

### Glass i)

The woven glass fiber fabric i) is a 2-2 Twill weave having a basis weight of 290-300 g/m² (grams per meter squared).

Yarns have a weight of 3*68 Tex in the warp direction and 204 Tex in the weft direction. The nominal construction of the woven glass fiber fabric is 7 yarns/cm in the warp and weft direction, with a thickness of 0.23 mm. The filament diameter is of about 9 microns. The bundle width is 1.25 mm, the gap between bundles in the weft direction is zero, and the gap between bundles in warp is 0.25 mm, with a coverage factor of 99%.

### Glass ii)

The woven glass fiber fabric ii) is a 2-2 twill weave having a basis weight of 600 g/m². The yarns have a weight of 1200 tex in warp and weft. The bundle width is 3.7 mm, the gap between bundles in warp and weft varies from touching to 0.75 mm, with a coverage factor of 98%.

Glass iii)

The woven glass fiber fabric iii) is a 2-2 twill weave having a basis weight of 300 g/m² and a coverage of 83%. The yarns have a weight of 600 tex in warp and weft. The bundle width is 2.5 mm, with the gap between bundles in warp and weft 2 mm, with a coverage factor of 83%.

### Glass iv)

The woven glass fiber fabric iv) is a blanched plain weave having a basis weight of 290 g/m². The yarns have a weight of 320 tex in warp and weft. The bundle width is 1.8 mm, with the gap between bundles 0.9 to 0.3 mm in warp and weft, with a coverage factor of 90%.

### Carbon Fiber

The carbon fiber is a uni-direction non-crimp fabric made from 50 k carbon fiber rovings spread to give a basis weight of 150 g/m². A glass or nylon stitching yarn is used to stabilize the structure.

### Preparation of the Composite Structures

All materials were prepared for lamination using an isobaric double belt press manufactured by the company Held. The machine is well known in the art and consists of two counter rotating steel belts driven by drums that move the material into the machine between the belts. Pressure is applied via a fluid to the belt and is hydrostatic in nature. The starting form of materials, here alternating stacks of fibrous material and film, will be subsequently described. These pass into the entry zone of the DBP where pressure is applied and the material heated from hot zones inside the DBP. The material then passes into a cooled zone where the laminate is cooled, still under pressure, and the final impregnated material removed from the laminator, which is preferably substantially void free material. Typical pressures applied during lamination range from 10-80 bar, and more preferably 40-60 bar. Typical temperature set-points of the machine are 360-400 deg C for such polyamide materials. The exit temperature was set to between 50 and 120 deg C, which is set to optimize cooling and release from the DBP steel belts.

### Preparation of Composite Structure Through Packet Lamination

A first series of packet lamination trials was performed as shown in Table 1 and Table 2. Packet lamination trials were performed by placing the desired stack of polymer films and woven glass fiber fabrics onto the DBP steel belt inside a rectangular cut out of an Aluminium sheet. This enabled the use of batch prepared samples rather than use of continuous roll form material.

In order to make the laminates described in tables 1 and 2 as example E1 and comparative examples C1 to C13, the following stacking sequences were used, defined by the two woven glass fiber fabric types used:
Five layers of woven glass fiber fabric glass i) were prepared with interlayered matrix resin composition film and outside layers of surface resin composition film to give the desired fiber volume fraction
Three layers of woven glass fiber fabric glass ii) were prepared with interlayered matrix resin composition film and outside layers of surface resin composition film to give the desired fiber volume fraction

The laminate stacks were hence prepared, dried, and sealed in moisture proof bags. Upon lamination, the bags were opened at the entrance of the laminator and were then laminated using the isobaric DBP machine with a peak temperature of 380° C. and at a pressure of 40 bar. The exit temperature was set to either 80° C. or 120° C.

### Measurement of Acoustic Emission

It was desired to measure and record acoustic events corresponding to micro-cracking after exit from the DBP and upon mechanical loading of the composite structure.

Acoustic emission (AE) non-destructive testing equipment, supplied by Mistras, France, was used to monitor and record micro-cracking after exit from the DBP during these experiments. Acoustic emission is a technique well known in the art and is based on the detection and conversion of high frequency elastic waves to electrical signals. This is accomplished by directly coupling piezoelectric transducers on the surface of the structure under test The acquisition thresholds for the experiment were set to exclude the constant environmental noise to give a good compromise between sensitivity to low amplitude AE events and the avoiding of system saturation.

The acoustic criticality (0 to 24) was calculated from these measurements taking in account both activity (number of hits) and intensity (amplitude)

where higher activity and intensity gave increased criticality points. Benchmarking was made with control recipe C1, giving an acoustic criticality of 2, which was known not to exhibit microcracking under these conditions, to set the level of AE corresponding to internal friction rather than micro-cracking.

Table 1 gives the criticality measured for acoustic emission at exit of the lamination machine with the acoustic method for example E1 and comparative examples C1 to C10. A criticality of less than 2 indicated equivalent behavior to the composite structure C1 made from aliphatic polyamide resin composition where acoustic emission is not expected.

While acoustic emission yields more data than aural scoring, and can see more significant factors in the data, a parallel method of aural assessment using a trained technician to listen to the acoustic events was also used and calibrated against the acoustic method for use in the following tests. This gave a score of 0 to 4 for both number and intensity of AE, where 0 is no acoustic emission or micro-cracking. A score of 0 was recorded for the control Rec C1, with no micro-cracking (but where internal acoustic non-critical events still occur).

Table 2 shows the aural scoring measured for acoustic emission at exit of the lamination machine for example 1 and comparative examples C1 and C11 to C13.

### Preparation of Composite Structure Through Continuous Lamination

The composite structures of examples C14, C15 and E2 to E8 in Table 3 were made by continuous lamination using continuous rolls of surface resin composition, matrix resin composition and woven glass fiber fabric and an isobaric double belt press made available by Held Technology, Shura, Germany. The composite structure composition is given in Table 3.

Tests were performed to examine aural acoustic emission for two stages as defined below.

Stage 1): no thermally induced micro-cracking during cooling immediately after lamination

None of the composite structures in Table 3 exhibited thermally induced micro-cracking/acoustic emission at exit from the DBP in a flat sheet form (i.e. no external mechanical stresses applied) as determined by aural assessment.

Stage 2) no mechanically induced micro-cracking on as made samples

Composite structures were subjected to a manually applied mechanical flexural load. Samples of 290×90 mm and nominally 1.5 mm thick were cut, dried, and tested in 3 point bending with a span of 180 mm to a displacement of 30 mm.

A score of 0 was given for no aural acoustic emission and 4 for the highest level, as determined by an experienced test engineer and recorded by video. Differences between resin microcracking and some limited early fiber fractures was also noted. The displacement of 30 mm was used to ensure a strain level below fiber fracture levels to monitor resin effects.

TABLE 1

| | C1 | C2 | C3 | E1 | C4 | C5 | C6 | C7 | C8 | C9 | C10 |
|---|---|---|---|---|---|---|---|---|---|---|---|
| Matrix resin | PA66 | PA6T/66 | PA6T/DT | PA6T/DT | PA6T/DT | PA6T/DT | PA6T/DT | PA6T/66 | PA6T/66 | PA6T/66 | PA6T/66 |
| composition | PA6 | | | PA6T/66 | PA6T/66 | PA6T/66 | PA6T/66 | | | | |
| Surface resin | PA66 | none | none | PA6I/6T | PA6I/6T | PA66 | PA66 | PA6I/6T | PA6I/6T | PA66 | PA66 |
| composition | PA6 | | | | | | | | | | |
| Fibrous | Glass ii) | Glass i) | Glass ii) | Glass i) | Glass ii) | Glass ii) | Glass i) | Glass ii) | Glass i) | Glass ii) | Glass i) |
| material | | | | | | | | | | | |
| Weave basis | 600 | 290-300 | 600 | 290-300 | 600 | 600 | 290-300 | 600 | 290-300 | 600 | 290-300 |
| Weight (g/m²) | | | | | | | | | | | |
| Weave | 98 | 99 | 98 | 99 | 98 | 98 | 99 | 98 | 99 | 98 | 99 |
| Coverage (%) | | | | | | | | | | | |
| Vf | 44 | 46 | 44 | 40 | 46 | 46 | 40 | 44 | 40 | 46 | 40 |
| thickness | 1.56 mm | 1.51 mm | 1.57 mm | 1.46 mm | 1.51 mm | 1.51 mm | 1.46 mm | 1.51 mm | 1.46 mm | 1.51 mm | 1.46 mm |
| Acoustic | 2 | 10.5 | 6.0-11 | 0.4 | 9 | 20.5 | 7 | 14.3 | 3.3 | 19.3 | 17 |
| Emission | | | | | | | | | | | |
| Criticality | | | | | | | | | | | |
| (0 to 24) | | | | | | | | | | | |
| Pass or fail? | PASS | FAIL | FAIL | PASS | FAIL | FAIL | FAIL | FAIL | FAIL | FAIL | FAIL |

TABLE 2

| | C1 | E1 | C11 | C12 | C13 |
|---|---|---|---|---|---|
| Matrix resin | PA66 | PA6T/DT | PA6T/DT | PA6T/DT | PA6T/DT |
| composition | PA6 | PA6T/66 | PA6T/66 | PA6T/66 | PA6T/66 |
| Surface resin | PA66 | PA6I/6T | none | PA6I/6T | PA6I/6T |
| composition | PA6 | | | | |
| Fibrous | Glass ii) | Glass i) | Glass i) | Glass iv) | Glass iii) |
| material | | | | | |
| Basis weight | 600 | 290-300 | 290-300 | 290 | 300 |
| (g/m²) | | | | | |
| Vf, % | 44 | 40 | 49 | 40 | 40 |
| Thickness, mm | 1.56 | 1.46 | 1.40 | 1.46 | 1.46 |
| Coverage | 98 | 99 | 99 | 89.7 | 82.9 |
| Aural acoustic | 0 | 0 | 1 | 1 | 2 |
| number | | | | | |
| rating (0-4) | | | | | |
| Aural acoustic | 0 | 0 | 1 | 0.5 | 2 |
| intensity | | | | | |
| rating (0-4) | | | | | |
| Pass or fail? | PASS | PASS | FAIL | FAIL | FAIL |

TABLE 3

| | C14 | C15 | E2 | E3 | E4 | E5 | E6 | E7 | E8 |
|---|---|---|---|---|---|---|---|---|---|
| Matrix resin composition | PA66 | PA66 | PA6T/DT | PA6T/DT | PA6T/DT | PA6T/DT | PA6T/66 | PA6T/66 | PA6T/DT |
| | PA6 | PA6 | PA6T/66 | PA6T/66 | PA6T/66 | PA6T/66 | PA6T/DT | PA6T/DT | PA6T/66 |
| | | | PA6I/6T | PA6I/6T | PA6I/6T | PA6I/6T | | | PA6I/6T |
| Surface resin composition | PA66 | PA66 | PA6I/6T | PA66 | PA66 | PA6T/DT | PA6T/DT | PA66 | PA66 |
| | PA6 | PA6 | | PA6 | PA6 | PA6T/66 | PA6T/66 | PA6 | PA6 |
| | | | | | | PA6I/6T | PA6I/6T | | |
| Woven glass fiber fabric | Glass ii) | Glass i) | Glass i) | Glass i) | Glass i) | Glass i) | Glass i) | Glass i) | Glass i) |
| Basis Weight (g/m²) | 600 | 290-300 | 290-300 | 290-300 | 290-300 | 290-300 | 290-300 | 290-300 | 290-300 |
| Glass weave coverage (%) | 98 | 99 | 99 | 99 | 99 | 99 | 99 | 99 | 99 |
| Carbon fibers | | | | | | | | | carbon i) |
| Vf, % | 44 | 45 | 51 | 49 | 51 | 52 | 52 | 50 | 44 |
| thickness, mm | 1.56 | 1.50 | 1.53 | 1.61 | 1.53 | 1.52 | 1.52 | 1.56 | 1.57 |
| Thermally induced acoustic | 0 | 0 | 0 | 0 | 0 | 0 | 0 | 0 | 0 |
| emission upon cooling from | | | | | | | | | |
| DBP exit [0-4] | | | | | | | | | |
| Mechanically induced | 0 | 0 | 0 | 0 | 0 | 0 | 0 | 0 | 0 |
| acoustic emission, DAM: | | | | | | | | | |
| 30 mm displacement [0-4] | | | | | | | | | |
| Pass or fail? | PASS | PASS | PASS | PASS | PASS | PASS | PASS | PASS | PASS |

What is claimed is:

1. A composite structure having a surface, which surface has at least a portion made of a surface resin composition, and comprising a woven glass fiber fabric, said woven glass fiber fabric being fully impregnated with a matrix resin composition, wherein
a. the matrix resin composition comprises a blend of PA6T/DT and PA66/6T
b. the surface resin composition is independently selected from an amorphous polyamide composition comprising PA6I/6T or a polyamide composition comprising a blend of PA66 and PA6
and wherein
c. the woven glass fiber fabric has a basis weight of between 280 to 320 g/m²
d. the coverage of the woven glass fiber fabric is of between 95% to 100%.

2. The composite structure according to claim 1, wherein the fiber volume fraction of the composite structure is of between 45 to 60%.

3. The composite structure according to claim 1, further comprising a fibrous material made of carbon fibers.

4. The composite structure according to claim 1, wherein the weight ratio of PA6T/DT and PA66/6T in the blend of the matrix resin composition is between from about 30:70 to about 70:30, preferably 50:50.

5. The composite structure according to claim 1, wherein the matrix resin composition further comprises PA6I/6T.

6. The composite structure according to claim 1, wherein the matrix resin composition and the surface resin composition comprise a blend of PA6T/DT, PA66/6T and PA6I/6T.

7. The composite structure according to claim 1, wherein the weight ratio of PA6T/DT, PA66/6T and PA6I/6T in the blend of the matrix resin composition and surface resin composition is about 40:40:20.

8. The composite structure according to claim, 1 wherein the weight ratios of PA66 and PA6 in the blend of the surface resin composition is of between 100:0 to 50:50, preferably 75:25.

9. The composite structure according to claim 1, wherein the woven glass fiber fabric has a twill 2-2 weave style.

10. The composite structure according to claim 1, wherein the yarns of the woven glass fiber fabric have a weight of 3*68 Tex in the warp direction and 204 Tex in the weft direction

11. The composite structure according to claim 1, wherein the nominal construction of the woven glass fiber fabric is 7 yarns/cm in the warp and weft direction

12. The composite structure according to claim 1, further comprising one or more additives selected from the group consisting of impact modifiers, heat stabilizers, oxidative stabilizers, reinforcing agents, rheology modifiers and flame retardants or combination thereof.

13. The composite structure according to claim 1 having a form of a sheet structure.

14. The composite structure according to claim 1 in the form of a component for automobiles, trucks, commercial airplanes, aerospace, rail, household appliances, computer hardware, hand held devices, recreation and sports, structural component for machines, structural components for buildings, structural components for photovoltaic equipment or structural components for mechanical devices.
